(19) United States
(12) Patent Application Publication
(10) Pub. No.: US 2022/0092596 A1
(43) Pub. Date: Mar. 24, 2022

(54) SYSTEMS AND METHODS FOR RECURRING PAYMENT MANAGEMENT

(71) Applicant: JPMorgan Chase Bank, N.A., New York, NY (US)

(72) Inventors: Courtney S. GOODRICH, Garnet Valley, PA (US); Whittney Anne LEVITT, New York, NY (US)

(21) Appl. No.: 15/143,122

(22) Filed: Apr. 29, 2016

(51) Int. Cl. G06Q 20/40; G06Q 20/42

(52) U.S. Cl. CPC G06Q 20/405; G06Q 20/42

(57) ABSTRACT

Systems and methods for recurring payment management are disclosed. In one embodiment, a method for recurring payment management may include (1) a computer processor for an issuer receiving, over a network, a plurality of card not present transactions using a customer's financial instrument, each card not present transaction involving a merchant; (2) the computer processor for the issuer communicating, to an electronic device associated with the customer, an identification of each merchant having a card not present transaction; (3) the computer processor receiving an action involving one of the merchants from the electronic device; and (4) the computer processor executing the requested action.

### BACKGROUND OF THE INVENTION

### 1. Field of the Invention

The present disclosure generally relates to systems and methods for recurring payment management.

### 2. Description of the Related Art

It is becoming more popular for customers to use credit cards to pay for recurring charges from merchants, schools, and utility providers. When a customer's credit card is compromised, lost, or updated (e.g., new expiration date) and a new credit card is issued, customers often have to either go through past charges to identify the merchants that will need new card information, or wait until the merchant contacts the customer with a payment issue.

### SUMMARY OF THE INVENTION

Systems and methods for recurring payment management are disclosed. In one embodiment, a method for recurring payment management may include (1) a computer processor for an issuer receiving, over a network, a plurality of card not present transactions using a customer's financial instrument, each card not present transaction involving a merchant; (2) the computer processor for the issuer communicating, to an electronic device associated with the customer, an identification of each merchant having a card not present transaction; (3) the computer processor receiving an action involving one of the merchants from the electronic device; and (4) the computer processor executing the requested action.

In one embodiment, the action may be to block a future card not present transaction with the merchant, to be notified of a future card not present transaction with the merchant, to provide updated financial instrument information to the merchant, to authorize at least one future card not present transaction with the merchant, to provide a merchant-specific token to the merchant, etc.

In one embodiment, the method may further include the computer processor identifying a merchant having a plurality of card not present transactions; and the computer processor communicating, to an electronic device associated with the customer, an identification of the merchant having the plurality of card not present transactions.

In one embodiment, the method may further include the computer processor determining an expected transaction amount for transactions with the merchant having the plurality of card not present transactions.

According to another embodiment, a method for recurring payment management may include (1) a computer processor for an issuer identifying a customer having a updated financial instrument, the updated financial instrument replacing a prior financial instrument, the prior financial instrument now invalid; (2) the computer processor for the issuer receiving a current transaction request with the merchant with the prior financial instrument; (3) the computer processor identifying a plurality of authorized card not present transactions using the customer's prior financial instrument with the merchant; and (4) the computer processor for the issuer authorizing the current transaction using the updated financial instrument.

In one embodiment, the method may further include the computer processor for the issuer providing the merchant with the updated financial instrument.

In one embodiment, the method may further include the computer processor for the issuer transmitting a request for approval for the current transaction to a mobile electronic device associated with the customer; and the computer processor for the issuer receiving approval for the current transaction from the mobile electronic device.

In one embodiment, the method may further include the computer processor for the issuer mapping the prior financial information to the updated financial instrument for the merchant; and the computer processor for the issuer authorizing a plurality of future transaction request with the prior financial instrument from the merchant.

According to another embodiment, a method for recurring payment management may include (1) a computer processor for an issuer identifying a customer having a updated financial instrument, the updated financial instrument replacing a prior financial instrument, the prior financial instrument now invalid; (2) the computer processor for the issuer receiving a current transaction request with the merchant with the prior financial instrument; (3) the computer processor identifying a plurality of authorized card not present transactions using the customer's prior financial instrument with the merchant; and (4) the computer processor for the issuer communicating the updated financial instrument to the merchant.

In one embodiment, the method may further include the computer processor for the issuer transmitting a request for approval for the current transaction to a mobile electronic device associated with the customer; and the computer processor for the issuer receiving approval for the current transaction from the mobile electronic device.

In one embodiment, the method may further include the computer processor for the issuer authorizing the current transaction using the updated financial instrument.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for recurring payment management according to one embodiment.

FIG. 2 depicts a method for recurring payment management according to one embodiment.

FIG. 3 depicts a method for payment management according to another embodiment.

### DETAILED DESCRIPTION OF PREFERRED EMBODIMENTS

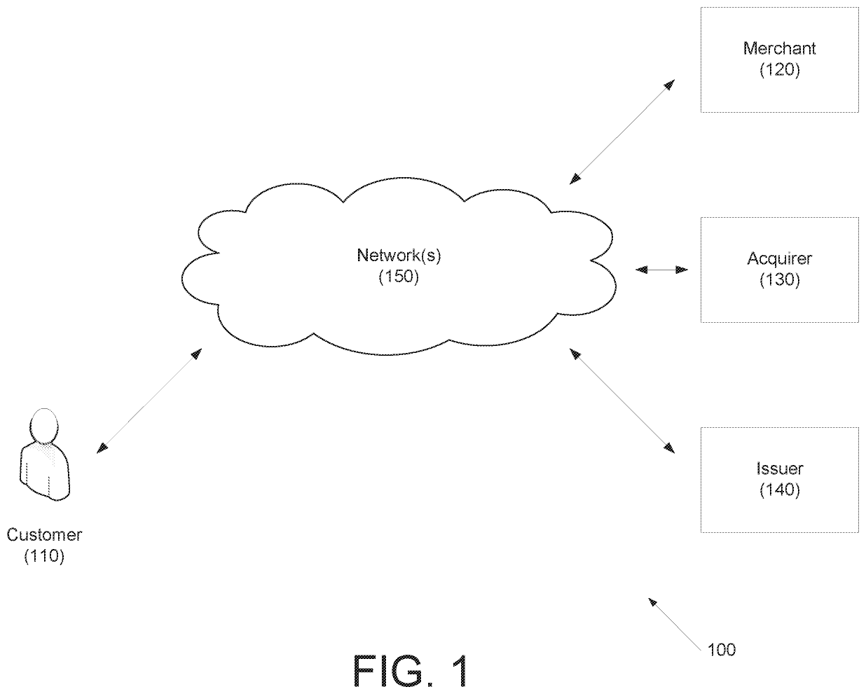

Several embodiments of the present invention and their advantages may be understood by referring to FIGS. 1-3.

Embodiments disclosed herein are generally directed to systems and methods for recurring payment management.

Referring to FIG. 1, a system for recurring payment management is disclosed according to one embodiment. System 100 may include customer 110, merchant 120, acquirer 130, issuer 140, and one or more network 150. In one embodiment, customer 110 may be any individual or entity that conducts a transaction using a financial instrument issued by issuer 140. Example financial instruments include credit cards, debit cards, tokens, etc.

Network(s) 150 may be any suitable communication network, payment network, combination thereof, etc. In one embodiment, network(s) 150 may also provide direct communication between any of customer 110, merchant 120, acquirer 130, and 140. In one embodiment, merchant 120 and acquirer 130, and/or acquirer 130 and issuer 140 may directly communicate with each other using one or more a separate networks (not shown).

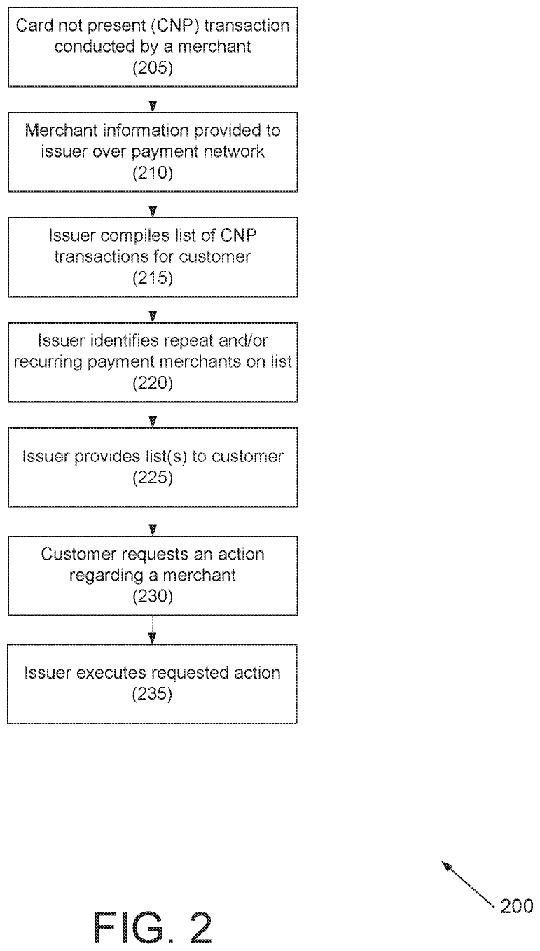

Referring to FIG. 2, a method for recurring payment management according to one embodiment is disclosed. In step 205, a card not present (CNP) transaction (or credit card on file transactions) using a customer's financial instrument may be conducted by a merchant. In one embodiment, the merchant may receive the customer's financial instrument over a network (e.g., the Internet for an online transactions), from a mobile wallet, from a mobile device, by telephone, by facsimile, by mail, or in person prior to the transaction being conducted (e.g., the payment instrument may be kept on file by the merchant).

Any other transaction in which the credit card information could be stored by the merchant (i.e., any transaction in which the credit card is not swiped or otherwise read) may be included. It should be noted that, in the context of this application, “CNP transactions” refers to card not present transactions, card on file transactions, and any transactions in which the credit card number may be stored by a merchant.

In step 210, as part of the CNP transaction, the issuer may receive merchant information along with some indication that the transaction was a CNP transaction. In one embodiment, this may be received over a payment network (e.g., VisaNet, ChaseNet, etc.).

In one embodiment, the indication that the transaction was a CNP transaction may be provided by the merchant and/or the acquirer.

In step 215, the issuer, or a third party, may compile a list of all merchants with which the customer has conducted CNP transactions. In another embodiment, the issuer may store the list in a database or some other storage.

In step 220, the issuer may identify repeat CNP transactions with the same merchant. In one embodiment, the number of repeat transactions, or the period within which the repeat transactions occur, may be specified as a threshold for identifying such transactions.

In one embodiment, the repeat CNP transactions may include CNP transactions with the same merchant as well as CNP transactions with the same merchant that may occur periodically (e.g., monthly) or pseudo-periodically (e.g., the first business day of each month, etc.), CNP transactions with the same merchant having approximately the same amount, CNP transactions with service providers/utilities (e.g., cellular phone company, electric company, etc.), etc. In one embodiment, the recurring CNP transactions may be compiled into a separate list from the CNP transactions. In another embodiment, the repeat and/or recurring CNP transactions may be indicated as such in the list of CNP transactions.

In step 225, the issuer may provide the list of CNP transactions and/or the list of CNP repeat and/or recurring transactions to the customer. In one embodiment, the issuer may provide the list of repeat and/or recurring CNP transactions to the customer. In another embodiment, the issuer may provide the list of all CNP transactions to the customer. In another embodiment, the issuer may provide the list of repeat and/or recurring CNP transactions and the list of all CNP transactions to the customer. In still another embodiment, the issuer may provide a list of all CNP transactions with repeat and/or recurring CNP transactions indicated to the customer.

In one embodiment, the period for which the lists are provided may be automatically determined based on an event (e.g., loss of financial instrument, fraud, etc.). For example, if an event occurs, the lists may be provided for the previous one or two statement periods. In another embodiment, the customer may request a specific period. For example, the customer may request all CNP transactions for the past six months. Any suitable way of selecting the period may be used as is necessary and/or desired.

In another embodiment, the customer may be informed whenever a CNP transaction in conducted. For example, the customer may be alerted by a push message, a text message, an email, etc.

In step 230, the customer may request an action based on a merchant entry in one of the lists. For example, the customer may report a fraudulent transaction, may request that new financial instrument information be provided to the merchant (e.g., for an expired or otherwise invalid financial instrument), may authorize a merchant to be provided with new financial instrument information should account information change, may block the merchant from CNP transactions, may block the merchant from all transactions, may request that a merchant-specific token be provided to the merchant, etc.

In one embodiment, the customer may request that financial instrument information in a mobile wallet be updated.

In another embodiment, the customer may request a notification (e.g., push notification, email, etc.) when a specific merchant submits a CNP transaction. In another embodiment, the customer may authorize future CNP transactions with a merchant using an expired or otherwise invalid (e.g., cancelled due to fraud) financial instrument.

In step 235, the issuer may execute the requested action. For example, if the customer requested that a repeat and/or recurring CNP merchant be provided with new financial instrument information, the issuer may provide the new financial instrument information to that merchant. In one embodiment, the issuer may require specific authorization from the customer to provide the new financial instrument information to the merchant.

An example of such authorization may involve having the customer provide certain digits of the new financial instrument to the merchant, “clicking” to approve the transmission of the new financial instrument, etc.

Examples of such authorization are disclosed in U.S. patent application Ser. No. 13/240,262, U.S. patent application Ser. No. 13/108,345, and U.S. Provisional Patent Application Ser. No. 61/468,409, the disclosure of which are hereby incorporated, by reference, in their entireties.

In one embodiment, the issuer may automatically provide recurring payment merchants with updated financial instrument information without specific customer instructions.

In one embodiment, the issuer may maintain a mapping between expired or otherwise invalid financial instrument and a new financial instrument so that repeat and/or recurring CNP transactions attempted using the expired or otherwise invalid financial instrument may be mapped to and conducted with the new financial instrument.

In one embodiment, if the customer has “blocked” a merchant from CNP transactions, the merchant may still conduct card present transactions.

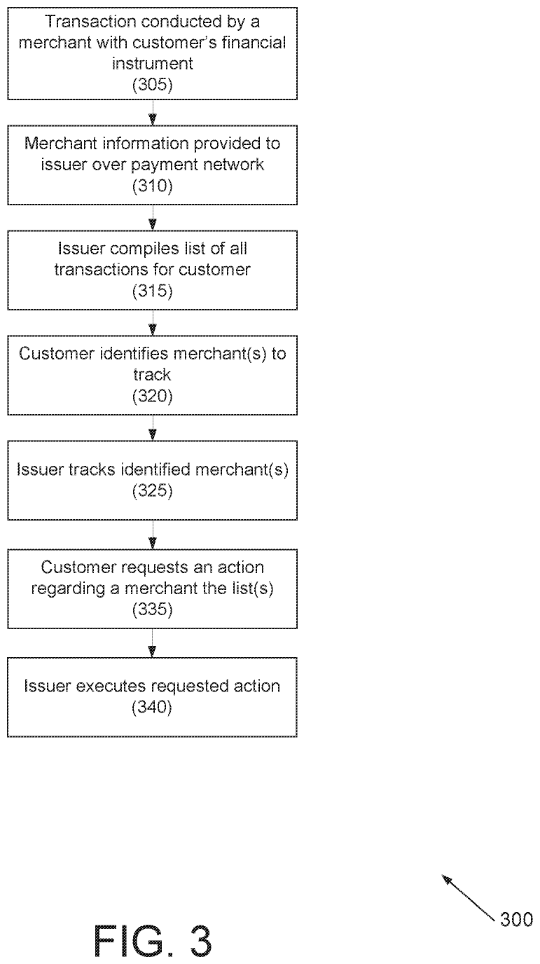

Referring to FIG. 3, a method for payment management according to one embodiment is disclosed. In step 305, a transaction may be conducted using the customer's financial instrument. In one embodiment, the transaction may be an in-person transaction, an online transaction, a phone transaction, a mail transaction, etc.

In step 310, as part of the transaction, merchant information may be provided to the issuer.

In step 315, the issuer may compile a listing of all transactions for a period of time. In one embodiment, the listing may be provided as a monthly statement. In another embodiment, the listing may be provided on a website, on a mobile application, etc.

In step 320, the customer may identify one or more merchants to track. In one embodiment, the merchant may select the merchant in any suitable fashion (clicking, tapping, swiping, etc.). In one embodiment, the customer may tag the merchant as having the customer's card on file, as being a recurring payment merchant, as being on a watch list, etc.

In one embodiment, the customer may also identify any transactions that may be fraudulent. In one embodiment, the customer may automatically initiate the fraud process using the mobile application. For example, by selecting a potentially fraudulent transaction, transaction information may be provided to a customer service representative, and the customer may be put in contact (e.g., phone, chat, video chat, email, etc.) with the customer service representative.

In another embodiment, if more than one cardholder shares the account, the financial instrument with which the transaction was conducted may be identified.

In one embodiment, the customer may identify merchant(s) with which the customer has not conducted a transaction.

In step 325, the issuer may track the identified merchant(s). In one embodiment, when the issuer receives a transaction, it may evaluate the transaction to determine if it is with a tracked merchant. If the transaction is with a tracked merchant, the customer may receive a notification (e.g., email, push alert, text message, etc.) In another embodiment, the customer may be presented with a listing of such merchants periodically.

In one embodiment, the customer may be notified if a transaction is outside of an expected frequency, amount, etc. The customer may provide information regarding the amount and/or period for the transaction; in another embodiment, the amount and/or frequency may be determined from past transactions.

In step 330, after receiving an identification of the merchant, the customer may request an action to be taken with the merchant. This may be similar to step 230, above.

In step 335, the issuer may execute the requested action. This may be similar to step 235, above.

In one embodiment, card present transactions may be reviewed and any potential recurring card present transactions may be identified. For example, a customer may pay a recurring bill with a merchant in person by physically presenting a credit card for payment. Upon identifying such a situation, the customer may be provided with a message (e.g., email, SMS, etc.) and asked if he or she wishes to establish a recurring payment program with the merchant. In one embodiment, the merchant may be provided with financial instrument information, a merchant-specific token, etc.

It should be recognized that although several embodiments have been disclosed, these embodiments are not exclusive and aspects of one embodiment may be applicable to other embodiments.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for user-initiated tracking of card not present (CNP) transactions, comprising:
a computer processor for an issuer, compiling a first listing of a plurality of CNP transactions, submitted for a financial instrument of a user, each of the plurality of CNP transactions comprising a merchant identifying information for a corresponding merchant;
evaluating the first listing for identifying, based on a user specified threshold, one or more recurring CNP transactions and the corresponding merchant for each of the one or more recurring CNP transactions, wherein the user specified threshold is associated with one of a total number of CNP transactions associated with a same corresponding merchant, a total number of CNP transactions with the same corresponding merchant and a same transaction amount, and a period of time between two or more consecutive CNP transactions with the same corresponding merchant;
compiling, by the computer processor, a second listing of a plurality of merchants associated with the plurality of CNP transaction, wherein the second listing further comprises an indication of one or more merchants associated with each of the one or more recurring CNP transactions;
transmitting, by the computer processor, the second listing of the plurality of merchants to an electronic device associated with the user;
transmitting, by the electronic device, a user-initiated action with respect to one or more merchants in the second listing, to the computer processor, wherein the user-initiated action comprises a selection, by the user, of one or more merchants from the second listing to be placed on a watch list for tracking;
the computer processor evaluating the corresponding merchant for each of the plurality of CNP transactions in the first listing against the watch list; and
the computer processor communicating, to the electronic device associated with the user, wherein the communicating comprises notifying the user of a presence, in the first listing, of one or more CNP transactions corresponding to a tracked merchant in the watch list.

2. The method of claim 1, wherein the user-initiated action is to block a future CNP transaction with the one or more merchants in the second listing.

3. The method of claim 1, wherein the user-initiated action is to be notified of a future CNP transaction with the one or more merchants in the second listing.

4. The method of claim 1, wherein the user-initiated action is to provide updated financial instrument information to the one or more merchants in the second listing.

5. The method of claim 1, wherein the user-initiated action is to authorize at least one future CNP transaction with the one or more merchants in the second listing.

6. The method of claim 1, wherein the user-initiated action is to provide a merchant-specific token to the one or more merchants in the second listing.

7. (canceled)

8. The method of claim 1, further comprising:
the computer processor determining an expected transaction amount associated with at least one recurring CNP transaction in the first listing of the plurality of CNP transactions.

9. A method for recurring payment management, comprising:
a computer processor for an issuer identifying a customer having a updated financial instrument, the updated financial instrument replacing a prior financial instrument, the prior financial instrument now invalid;
the computer processor for the issuer receiving a current transaction request with the merchant with the prior financial instrument;
the computer processor identifying a plurality of authorized card not present transactions using the customer's prior financial instrument with the merchant; and
the computer processor for the issuer authorizing the current transaction using the updated financial instrument.

10. The method of claim 9, further comprising:
the computer processor for the issuer providing the merchant with the updated financial instrument.

11. The method of claim 9, further comprising:
the computer processor for the issuer transmitting a request for approval for the current transaction to a mobile electronic device associated with the customer; and
the computer processor for the issuer receiving approval for the current transaction from the mobile electronic device.

12. The method of claim 9, further comprising:
the computer processor for the issuer mapping the prior financial information to the updated financial instrument for the merchant; and
the computer processor for the issuer authorizing a plurality of future transaction request with the prior financial instrument from the merchant.

13. A method for recurring payment management, comprising:
a computer processor for an issuer identifying a customer having a updated financial instrument, the updated financial instrument replacing a prior financial instrument, the prior financial instrument now invalid;
the computer processor for the issuer receiving a current transaction request with the merchant with the prior financial instrument;
the computer processor identifying a plurality of authorized card not present transactions using the customer's prior financial instrument with the merchant; and
the computer processor for the issuer communicating the updated financial instrument to the merchant.

14. The method of claim 13, further comprising:
the computer processor for the issuer transmitting a request for approval for the current transaction to a mobile electronic device associated with the customer; and
the computer processor for the issuer receiving approval for the current transaction from the mobile electronic device.

15. The method of claim 9, further comprising:
the computer processor for the issuer authorizing the current transaction using the updated financial instrument.

16. The method of claim 1, wherein the communicating of the identification of each merchant in the plurality of merchants associated with the listing is triggered upon a predetermined event occurring.

17. The method of claim 1, wherein the communicating of the identification of each merchant in the plurality of merchants associated with the listing is triggered in response to a request from the customer.

18. The method of claim 1, wherein further the identification comprises a requested time frame of CNP transactions.

19. The method of claim 2, wherein the one or more merchants can still conduct future card present transactions.
